(19) United States
(12) Patent Application Publication
(10) Pub. No.: US 2006/0093386 A1
(43) Pub. Date: May 4, 2006

(54) Image forming apparatus

(75) Inventor: Makoto Oki, Moriya-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/253,720

(22) Filed: Oct. 20, 2005

(30) Foreign Application Priority Data
Nov. 2, 2004 (JP) 2004-319890

(51) Int. Cl. G03G 15/00

(52) U.S. Cl. 399/49

(57) ABSTRACT

An image forming apparatus includes: an image bearing member moving in a predetermined direction; an image forming device for forming an image on the image bearing member; a detecting device for detecting an image to be detected on the moving image bearing member at a detection position; a controller for variably controlling an image formation condition of the image forming device based on the result of detection by the detecting device; and a moving device for moving the detection position of the detecting device in the, predetermined direction while the detecting device is detecting the image to be detected.

### BACKGROUND OF THE INVENTION

1. Field of the Invention

The present invention relates to an image forming apparatus using an electrophotographic method, an electrostatic recording method, or the like, in particular, to an image forming apparatus for detecting an image to be detected, which is formed on an image bearing member.

2. Related Background Art

Up to now, an image forming apparatus such as a copy machine or a printer using an electrophotographic method is known. In such an image forming apparatus, an electrostatic image formed on an electrophotographic photosensitive member (hereinafter, referred to simply as a “photosensitive member”) serving as an image bearing member is developed as a developer image by a developer. Then, the developed image is transferred onto a recording material to be fixed.

There also exists, for example, a color image forming apparatus using an electrophotographic method, which allows, for example, the formation of a full-color image by using developers of a plurality of colors (generally, four colors, i.e., yellow, magenta, cyan, and black). As the color image forming apparatus, a color image forming apparatus including a plurality of developing devices for a single photosensitive member, which uses any one of the following procedures (i) to (iii), is known. Specifically, (i) electrostatic images in accordance with sequentially color-separated image information are sequentially formed on a photosensitive member. At the same time, the electrostatic images are developed. After developer images of a plurality of colors are superposed on the photosensitive member, the images are transferred to a recording material. (ii) Developer images to be formed on a photosensitive member are sequentially transferred to a recording material on a recording material bearing member so that the developer images of a plurality of colors are superposed on the recording material. (iii) Developer images formed on a photosensitive member are sequentially transferred to an intermediate transfer member. After being superposed on the intermediate transfer member, the developer images of a plurality of colors are transferred onto a recording material. Thereafter, the developer images are fixed to obtain a recorded image.

As the color image forming apparatus, the following one is also known. A plurality of photosensitive members are arranged along a moving direction of surfaces of a recording material bearing member or an intermediate transfer member. Developer images formed on the respective photosensitive members are sequentially transferred onto a recording material on the recording material bearing member so that the developer images of a plurality of colors are superposed on the recording material. Alternatively, after the developer images of a plurality of colors are sequentially transferred to the intermediate transfer member to be superposed on the intermediate transfer member, the superposed images are transferred to the recording material. Then, the images are fixed to obtain a color recorded image.

Conventionally, for example, in the case where a two-component developer containing toner and carrier is used as a developer, the toner in the developer is consumed with an image forming operation. Therefore, the amount of toner approximately corresponding to the amount used in a development process is supplied to the developer. Specifically, for example, in a developing device using the two component developer containing toner and carrier, keeping a mixture ratio of the toner (T) and the carrier (C) in the developer, that is, T/D (D=T+C) (indicating a “toner density” of the developer; hereinafter, also referred to as a “T/D ratio”) constant is important for appropriately maintaining an image density. Therefore, conventionally, various types of auto toner replenisher (ATR) serving as means for detecting a toner density of a developer and controlling the toner density in a developing device have been proposed.

As a method of measuring the T/D ratio of the developer in the ATR, the following method is known. Specifically, a latent image at a fixed potential (a standard electrostatic latent image or a reference electrostatic latent image) is formed on a photosensitive member independently of normal image formation. By directly developing the latent image, an image for developer density control corresponding to a patch-like standard density pattern (a standard image or a reference image) is formed. Subsequently, a density of the image for developer density control is optically detected using an optical sensor serving as developer image detecting means on the photosensitive member or on a member onto which transfer is performed (a recording material bearing member or an intermediate transfer member) after the transfer from the photosensitive member to the member to which transfer is performed. Then, by using the correlation between the density of the image for developer density control and the T/D ratio, the T/D ratio is obtained. The above-described method is called a patch detecting method (a patch detecting ATR) (for example, see “Electrophotography—Bases and Applications” compiled by the Society of Electrophotography of Japan, CORONA PUBLISHING CO., LTD. Jun. 15, 1988 pp286-287).

Generally, a color image forming apparatus using toner of a plurality of colors, in particular, includes a lookup table for converting an image signal into a signal value in accordance with an engine characteristic to obtain a desired density tone characteristic. In the case of the full color image forming apparatus, the lookup table (γ-LUT) is generally provided for each of the colors, i.e., yellow, magenta, cyan and black. The lookup table is optimized for each color to allow a desired full color image to be output.

However, the characteristics of the electrophotographic method are likely to change depending on a surrounding environment, a status of use and the like. Therefore, under fixed image forming conditions, it is difficult to constantly output images in stabilized hue or tone.

In order to cope with the above problem, a latent image at a fixed potential (a standard electrostatic latent image or a reference electrostatic latent image) is formed on a photosensitive member independently of normal image formation. By directly developing the latent image, an image for tone correction control corresponding to a patch-like standard density pattern (a standard image or a reference image) is formed. Normally, the images for tone correction control at a plurality of tone levels are formed for each color. Next, a density of the image for tone correction control is optically detected on the photosensitive member or a transfer member onto which the developer image is transferred from the photosensitive member, by using an optical sensor serving as developer image detecting means. Then, based on the detected information, image forming conditions are controlled to obtain desired tone characteristics (patch detection tone correction). More specifically, the lookup table is corrected, or a charging condition or a developing condition of the photosensitive member for forming an electrostatic image is changed. In other words, light is radiated from a light source such as an LED provided for a patch sensor. The reflected light is received by an electro-optical element. An output value is subjected to density conversion to detect the density of toner in a patch-like pattern obtained by developing an electrostatic image formed by an image signal for tone control. Based on information of the detected density signal, a new lookup table is prepared or corrected to maintain desired tone characteristics.

As described above, conventionally, for adjustment (control) of various image adjustment parameters such as the amount of supplement of toner, a lookup table for tone correction, a charging condition of the photosensitive member, and a developing condition as the image forming conditions in the developer density control or the tone correction control, a patch-patterned standard image (hereinafter, referred to as a “patch image”) is formed. The patch image is then detected by an optical sensor (a patch sensor) serving as developer image detecting means.

Registration (misregister) correction control is performed based on the result of detection obtained by using a registration detection sensor corresponding to an optical sensor for detecting an image for registration correction control (a registration detection image). Specifically, in the registration correction control, for example, in an image forming apparatus including a plurality of image forming portions, each including a photosensitive member, a predetermined patch-patterned image or line image is transferred from each photosensitive member to an intermediate transfer member. The transferred image is detected by an optical sensor serving as developer image detecting means. Then, based on positional information of the image for registration correction, image adjustment parameters such as an image writing (exposure) timing to the photosensitive member are adjusted (controlled) as an image forming condition in each of the image forming portions.

As the implementation frequency of the adjustment of the image adjustment parameters by the detection of a patch image and the registration correction by the detection of the registration detection image becomes higher, the adjustment and registration correction can be more appropriately executed. In order to increase the number of images that can be formed in a predetermined time, the patch image and the registration detection image corresponding to images to be detected are formed between images (between images to be output) on an image bearing member during the formation of continuous images. Furthermore, the image to be detected is detected by a sensor during the formation of the images to be output. By reducing a distance between images as much as possible, the number of images that can be formed in a predetermined time can be increased. Therefore, the image to be detected is formed to be small.

If the image to be detected is formed small, however, precise detection cannot be performed in some cases. Specifically, in order to eliminate the effect of noise on the sensor during the detection of the image to be detected, it is necessary to sufficiently increase a detection time so as to average the detected data. If the image to be detected is small, the sensor has a shorter time for detection. Accordingly, precise detection cannot be performed.

Therefore, in order to increase the time required by the sensor for detection, a method disclosed in Japanese Patent Application Laid-open No. 2003-131538 is used. According to Japanese Patent Application Laid-open No. 2003-131538, a moving speed of the image bearing member bearing the image to be detected for detection of the image to be detected is set slower than that of the image bearing member for normal image formation.

If the method disclosed in Japanese Patent Application Laid-open No. 2003-131538 is employed, however, time for stabilizing the moving speed is required when the moving speed of the image bearing member is changed. In the state where the moving speed is unstable, the normal image and the image to be detected cannot be formed. As a result, there arises a problem in that the amount of images that can be formed in a predetermined time is reduced.

### SUMMARY OF THE INVENTION

Therefore, the present invention has an object of enabling precise detection of an image to be detected while preventing the amount of images that can be formed in a predetermined time from being reduced.

The present invention has another object to provide an image forming apparatus includes:
an image bearing member, which moves in a predetermined direction;
image forming means for forming an image on the image bearing member;
detecting means for detecting an image to be detected on the moving image bearing member at a detection position;
control means for changing an image formation condition of the image forming means based on a result of detection by the detection means; and
moving means for moving the detection position of the detecting means in the predetermined direction while the detecting means is detecting the image to be detected.

### BRIEF DESCRIPTION OF THE DRAWINGS

FIG. 1 is a schematic configuration view of a substantial part of an embodiment of an image forming apparatus according to the present invention;

FIG. 2 is a schematic view showing an example of a patch sensor;

FIG. 3 is a block diagram schematically showing an example of a control aspect of the image forming apparatus according to the present invention;

FIG. 4 is a schematic configuration view of a substantial part of an embodiment of moving means;

FIG. 5A is a schematic view showing a locus of a light irradiation spot of a conventional patch sensor;

FIG. 5B is a schematic view showing a locus of a light irradiation spot of a patch sensor according to the present invention;

FIGS. 6A and 6B are schematic configuration views of a substantial part of another embodiment of the moving means;

FIG. 7A is a schematic view showing the locus of the light irradiation spot of the conventional patch sensor;

FIG. 7B is a schematic view showing the locus of the light irradiation spot of the patch sensor according to the present invention;

FIG. 8 is a schematic view for illustrating another embodiment of the moving means of the patch sensor;

FIG. 9A is a schematic configuration view of a substantial part of another embodiment of the moving means;

FIG. 9B is a schematic configuration view of a substantial part of a further embodiment of the moving means;

FIG. 10 is an explanatory view for illustrating an output when the patch sensor is rotated;

FIG. 11 is a schematic configuration view of an embodiment of the moving means provided in the patch sensor;

FIG. 12 is an exploded view showing a mirror drive section in a fifth embodiment;

FIG. 13 is a sectional view of FIG. 12, showing a magnetized state of a permanent magnet formed on a movable plate;

FIGS. 14A, 14B, 14C and 14D are explanatory views, each for illustrating the arrangement of planar coils, a hard magnetic film and soft magnetic films in a light deflector;

FIG. 15 is a diagram showing a state of magnetic flux lines by coils, obtained as a result of a simulation;

FIG. 16 is a diagram showing a state of magnetic flux lines when the soft magnetic films are formed on lower sides of the coils shown in FIG. 15, obtained as a result of a simulation;

FIG. 17 is an enlarged view of a center part of FIG. 16, illustrating the relation between the position of the movable plate and a direction of a magnetic field;

FIG. 18 is a schematic configuration view of a substantial part of another embodiment of the image forming apparatus to which the present invention is applicable;

FIG. 19 is a schematic configuration view of a substantial part of another embodiment of the image forming apparatus to which the present invention is applicable;

FIG. 20 is a schematic configuration view of a substantial part of another embodiment of the image forming apparatus to which the present invention is applicable; and

FIG. 21 is an explanatory view for illustrating tone correction control.

### DESCRIPTION OF THE PREFERRED EMBODIMENTS

The present invention solves the above problem by providing “moving means for moving a detection position of the detection means in the predetermined direction while the detection means is detecting the image to be detected”. Specifically, time required for the detecting means to detect the image to be detected can be increased while a speed of an image bearing member bearing the image to be detected is kept to the same as that during normal image formation. In this manner, precise detection of the image to be detected is made possible while preventing the reduction of the amount of images that can be formed within a predetermined time period.

Hereinafter, an image forming apparatus according to the present invention will be described in further detail with reference to the accompanying drawings.

### FIRST EMBODIMENT

<Entire Configuration and Operation of Image Forming Apparatus>

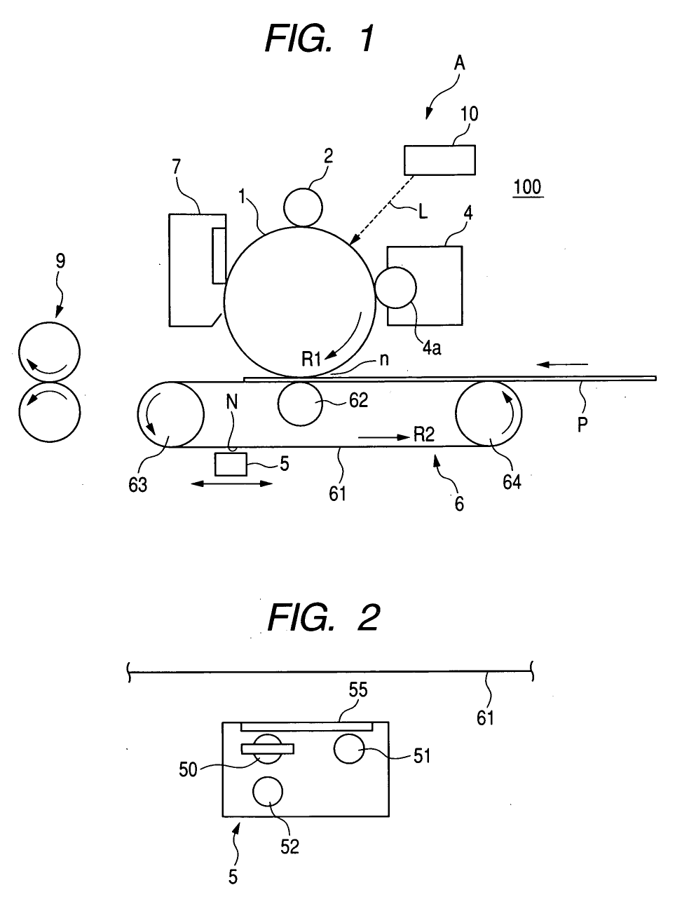

First, the entire configuration and the operation of an image forming apparatus according to a first embodiment will be described. FIG. 1 is a schematic configuration view showing a substantial part of an image forming apparatus A according to the first embodiment. The image forming apparatus A according to this embodiment is a laser beam printer (hereinafter, referred to simply as the “image forming apparatus”) that employs an electrophotographic method to enable the formation of an image on a recording material, for example, recording paper, a plastic sheet (an OHP sheet), or cloth, in accordance with image information from external equipment such as: an image reading apparatus (a document reading apparatus) provided for an image forming apparatus main body 100 or connected to the image forming apparatus main body 100 so as to be communicable with each other; or a personal computer removably connected to the image forming apparatus main body 100.

For simplification of the description, the image forming apparatus capable of forming a monochrome image in a single image forming portion will be first described as an example in this embodiment. However, the present invention is not limited thereto. As described below, the present invention is also suitably applicable to a color image forming apparatus.

The present invention can be applied to any image forming apparatus as long as the image forming apparatus forms a latent image corresponding to an image information signal on an image bearing member such as a photosensitive member or a dielectric by an electrophotographic method, an electrostatic recording method, or the like, develops the formed latent image by a developing device to form a visible image (a toner image), directly or indirectly transfers the visible image onto a recording material such as a paper sheet, and fixes the transferred image as a permanent image by fixing means. An electrostatic latent image can be formed by charging the photosensitive member followed by exposure to light when the image bearing member is a photosensitive member and by using an ion head for directly imparting electric charges when the image bearing member is a dielectric.

The image forming apparatus A includes a cylindrical photosensitive member (hereinafter, referred to as a “photosensitive drum”) serving as a first image bearing member. On an outer circumference of the photosensitive drum 1, a primary charger 2 serving as charging means, an exposure device (a laser scanner device) 10 serving as exposure means, a developing device 4 serving as developing means, a belt transfer device 6 serving as transfer means, and a cleaning device (a cleaner) 7 serving as cleaning means are provided.

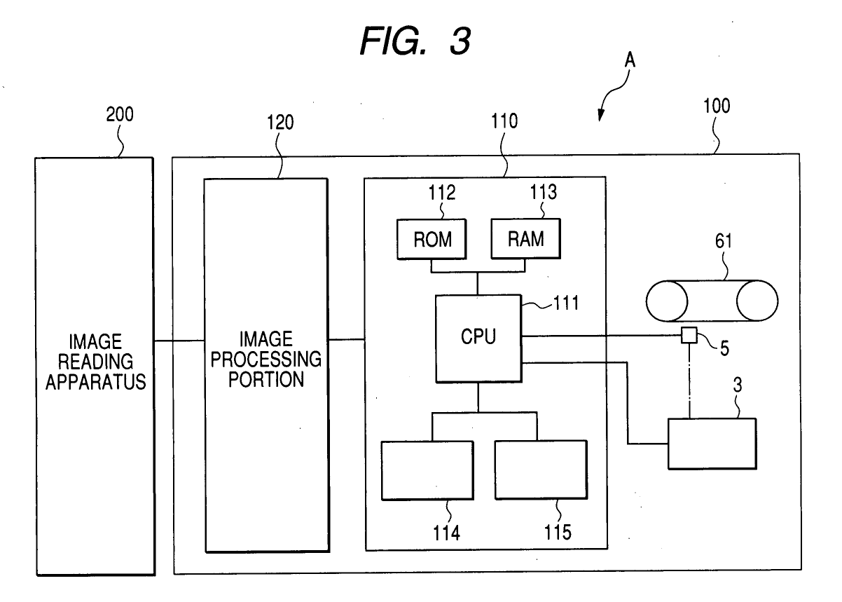

For example, the case where an image reading apparatus 200 (FIG. 3) is connected to the image forming apparatus main body 100 will be described. For an image forming operation (a copy operation), an image of an original placed on an original plate (an original placing platen glass) of the image reading apparatus is first optically read. Then, the reflected light is converted into an electric signal. Specifically, light reflected when light is radiated on the original passes through a mirror system and a lens system, is input to a CCD corresponding to a photoelectrical conversion element, and is converted into an electric signal. An analog image signal read and obtained by the CCD is amplified by an amplifier to a predetermined level. Then, the amplified signal is converted by an analog/digital converter (an A/D converter) into, for example, an 8-bit (0 to 255 tones) digital image signal. The digital image signal is input to an image processing portion (a video controller) 120 (FIG. 3) provided for the image forming apparatus main body 100.

Next, in the image processing portion 120, after the digital image signal is supplied to a γ-converter (in this embodiment, a converter constituted of 256-byte data that performs density conversion by a lookup table method) and is subjected to γ-correction, the digital image signal is input to a digital to analog converter (a D/A converter). At this time, the digital image signal is converted into an analog image signal again so as to be supplied to one of inputs of a comparator of a pulse width modulating circuit 115 provided in an image forming control portion 110 (FIG. 3). A triangular waveform signal in a predetermined cycle, which is generated from a triangular waveform generating circuit, is supplied to the other input of the comparator. The analog image signal supplied to one of the inputs of the comparator is compared with the triangular waveform signal so as to be subjected to pulse wave modulation.

A binarized image signal which has been subjected to pulse width modulation is input to a laser drive circuit of the laser scanner device 10 so as to be used as an ON/OFF control signal of light emission of a laser diode. Laser light L emitted from the laser diode is scanned in a primary scanning direction by a polygon mirror. Then, after passing through an fO-lens and a reflection mirror, the laser light L is radiated on the cylindrical photosensitive drum 1 serving as the image bearing member rotating in a direction indicated by an arrow R1 in FIG. 1.

On the other hand, the photosensitive drum 1 is negatively charged in this embodiment in an approximately uniform manner by the primary charger 2, which is formed in a roller shape in this embodiment. Thereafter, the photosensitive drum 1 is irradiated with the laser light L described above. As a result, an electrostatic latent image is formed in accordance with the image signal on-the photosensitive drum 1. The electrostatic latent image is visibly imaged as a developer image (a toner image) by the developing device 4.

Herein, image forming means includes the laser scanner device 10, the primary charger 2, and the developing device 4. A DC bias component in accordance with electrostatic latent image formation conditions and an AC bias component for improving a development efficiency are superposed to be applied to a developer bearing member 4a provided for the developing device 4. The developer bearing member 4a is formed in a roller shape that is capable of rotating about a rotational shaft approximately parallel to a rotational axis direction of the photosensitive drum 1. The developer bearing member 4a carries a developer borne on the surface to a portion opposed to the photosensitive drum 1 (a development area) along with the rotation. Then, the toner in the developer is transferred from the developer bearing member in accordance with the electrostatic image formed on the photosensitive drum 1. As a result, a developer image is formed on the photosensitive drum 1.

The toner image is electrostatically transferred to a recording material P by a belt transfer device 6. In this embodiment, the belt transfer device 6 includes a belt-like recording bearing member stretched between two rollers, i.e., a driving roller 63 and a driven roller 64, that is, a transfer belt (a recording material bearing belt) 61. The drive from a drive motor (not shown) serving as drive means (a drive source) is transferred to the driving roller 63, so that the transfer belt 61 is endlessly driven in a direction indicated by an arrow R2 in FIG. 1. A transfer charger 62 serving as a transfer member formed in a roller shape in this embodiment is provided to oppose the photosensitive drum 1 through the transfer belt 61. As a result, at the position of the transfer charger 62, a transfer portion “n” is formed between the transfer belt 61 and the photosensitive drum 1. The toner image on the photosensitive drum 1 is transferred to the recording material P retained on the transfer belt 61 by the function of the transfer charger 62. In a transfer process, a voltage at the polarity opposite to normal electric polarity of the toner in the developer is applied to the transfer charger 62. The recording material P is carried to the transfer belt 61 by recording material supplying means (not shown) including a recording material housing section, a recording material carrying member, and the like.

As described in detail below, in this embodiment, an optical sensor (a patch sensor) 5 serving as developer image detecting means is provided to face the transfer belt 61. The transfer belt 61 also functions as a second image bearing member onto which a reference image (a patch image) corresponding to an image for control (an image to be detected) is transferred from the photosensitive drum 1 so as to detect the standard image thereon.

Subsequently, the recording material P onto which the toner image is transferred is separated from the transfer belt 61 so as to be carried to a fixing device 9 serving as fixing means. Then, the fixing device 9 pressurizes and heats the recording material P bearing the unfixed toner image so as to fix the toner image to the recording material P. Thereafter, the recording material P is exhausted from the image forming apparatus.

The toner remaining on the photosensitive drum 1 after the transfer of the toner image onto the recording material P (a residual toner after transfer) is removed from the photosensitive drum 1 by a cleaner 7. In this manner, the photosensitive drum 1 is cleaned and subsequently returns to the primary charging process so as to be repeatedly used for image formation. Although a planar blade is abutted against the photosensitive drum 1 so as to sweep the toner away is used as cleaning means in this embodiment, the present invention is not limited thereto. Any other methods such as a method of rotating a brush-like roller so as to collect the toner from the photosensitive drum 1 can also be used.

In this embodiment, image forming means for forming an image on the transfer belt (the second image bearing member) 61 is constituted by the photosensitive drum 1, the primary charger 2, the exposure device 10, the developing device 4, the transfer charger 62, and the like.

FIG. 3 is a schematic control block diagram of this embodiment. The image forming apparatus A includes an image processing control portion 110 for performing overall control on the operation of the image forming apparatus A. The image processing control portion 110 includes a CPU 111 as a central element of control. A ROM 112 storing a program executed by the CPU 111 and various data and a RAM 113 used as a working memory or the like are connected to the CPU 111. A reference image generating circuit (a reference image generating circuit) 114, a pulse width modulating circuit 115, and the like are provided in the image forming control portion 110. The CPU 111 sequentially operates the image forming apparatus A in accordance with the data, the program, and the like stored in the ROM 112.

The image processing portion (the video controller) 120 is connected to the image forming control portion 110. The image processing portion 120 receives an image signal from external equipment such as the image reading apparatus 200 communicably connected to the image forming apparatus main body 100 or the personal computer. At the same time, the image processing portion 120 converts the received signal into a signal associated with image formation in the image forming apparatus A so as to transmit the converted signal to the CPU 111 in the image forming control portion 110. In accordance with the image forming signal, the CPU 111 controls the operation of each portion of the image forming apparatus A. In this embodiment, as described below in detail, the CPU 111 in the image forming control portion 110 generates a control signal for operating moving means for moving a detection position of the patch sensor 5. Furthermore, the CPU 111 also functions as control means for variably controlling the image forming conditions of the image forming means based on the result of detection by the patch sensor 5.

<Patch Sensor>

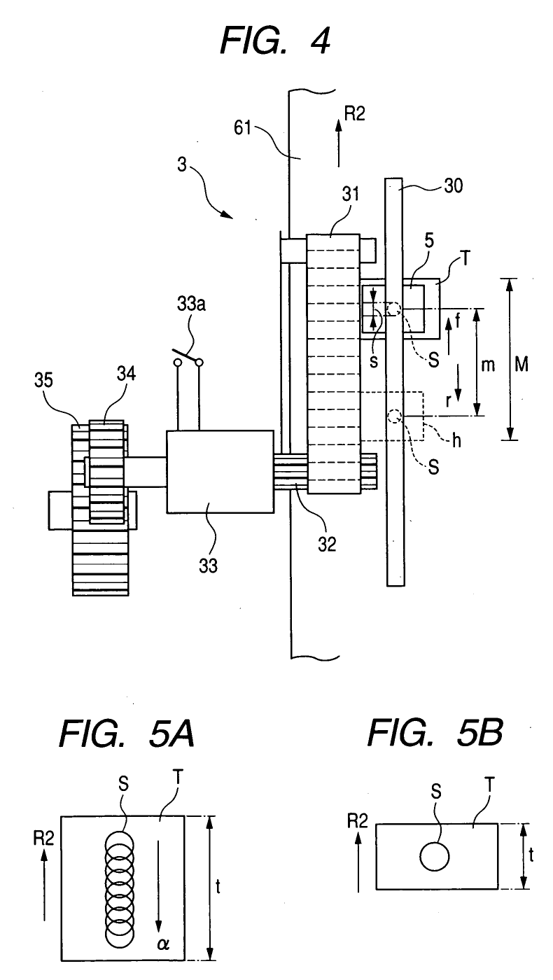

In this embodiment, as the detecting means (the developer image detecting means) of detecting the patch image corresponding to the image for control on the transfer belt (the second image bearing member) 61 at a detection position N, the optical sensor (the patch sensor) 5 is provided below the transfer belt 61 in FIG. 1 so as to be opposed to the transfer belt 61. As described below in detail, in this embodiment, the image forming apparatus A includes moving means 3 (FIG. 4) allowing the detection position of the patch sensor 5 to be moved when the patch sensor 5 detects the patch image corresponding to the image for control.

FIG. 2 shows a schematic configuration of the patch sensor 5 used in this embodiment. The patch sensor 5 includes: a light source 50; a light-receiving element for density measurement 51, which receives reflected light when detection light is radiated onto a toner image from the light source 50; and a light-receiving element for light amount adjustment 52, which directly receives the amount of light from the light source 50 so as to keep the amount of light from the light source 50 constant. In this embodiment, a light-emitting diode (an LED) is used as the light source 50, whereas a photodiode (a PD) corresponding to a photoelectric conversion element is used as the light-receiving element for density measurement 51.

In other words, at this time, the detection position N is a position to which the light source 50 radiates light to the patch image (an irradiation position). The patch sensor 5 generates a signal in accordance with the amount of toner adhered on the toner image. As a result, the amount of toner adhered onto the toner image can be detected. However, the present invention does not limit the optical sensor (the patch sensor) itself corresponding to the developer image detecting means to that explained in this embodiment. An available optical sensor can be appropriately used as the optical sensor of the present invention.

Next, a method of detecting a density of the patch image formed on the transfer belt 61 will be described.

A standard image generating circuit (a reference image generating circuit) 114 serving as standard image generating means for generating a standard image signal (a reference image signal) having a signal level corresponding to a predefined density is provided. The standard image signal from the standard image generating circuit 114 is supplied to the pulse width modulating circuit 115 to generate a laser drive pulse having a pulse width corresponding to the above-described predefined density. The pulse width modulating circuit 115 supplies the laser drive pulse to a semiconductor laser (not shown) of the laser scanner device 10. The laser light is emitted during a time period corresponding to the pulse width to scan the photosensitive drum 1 with the laser light. As a result, a standard electrostatic latent image (a reference electrostatic latent image) corresponding to the above-described predefined density is formed on the photosensitive drum 1.

Subsequently, the standard electrostatic latent image is developed by the developing device 4. The developed patch image is transferred to the transfer belt 61 in this embodiment. The patch image thus obtained is irradiated with light from the light source 50 of the patch sensor 5. The reflected light is received by the photoelectric conversion element 51. The amount of reflected light depends on (is correlated with) the amount of adhered toner on the toner image. In the case of a black toner, for example, as the amount of adhered toner increases (that is, an image density increases), the amount of reflected light generally decreases. In the case of a color toner such as yellow, magenta, or cyan, as the amount of adhered toner increase (that is, an image density increases), the amount of reflected light also increases. As a result, an output signal (an output voltage) from the photoelectric conversion element 51 depends on (is correlated with) the amount of adhered toner on the toner image. Therefore, the amount of reflected light can be associated with the density of the above-described patch image by a conversion formula representing the relation between the output voltage (the sensor output voltage) and the image density.

The patch sensor 5 serving as the developer image detecting means can be used for detecting the image for developer density control and the image for tone correction control as in the conventional example as described above. Specifically, an example of a method of using the patch sensor 5 will be described below.

(1) The patch sensor 5 can be used to correct a developer density (a toner density (a T/D ratio) in the case of a two component developer and the amount of the toner in the case of a mono-component developer) in the developing device 4, which is changed by development. Specifically, the electrostatic latent image formed by the image signal for developer density control is developed to form a patch-patterned toner image (a patch image) serving as the image for developer density control. Then, the patch image is irradiated with light from the light source 50 of the patch sensor 5. The reflected light is received by the light receiving element for density measurement 51. An output value from the light receiving element for density measurement 51 is subjected to density conversion so as to detect the density of the patch image. As a result, toner is supplied to the developing device 20 in accordance with a conversion table of the predefined detection density and a required amount of toner supply (the patch detecting ATR). Typically, by supplying the toner to the developing device 4 so that a density of the patch image obtained by developing the standard latent image at a predetermined electric potential becomes constant, the developer density (the toner density and the like) in the developing device 4 can be kept constant so as to appropriately keep the image density. The amount of toner supply can be adjusted by, for example, the, CPU (control means) 111 for controlling the amount of drive of a carrier member such as a screw provided for a toner carrier path from a toner replenishment container (not shown) containing toner for replenishment to the developing device 4 in accordance with the density of the patch image detected by the patch sensor 5.

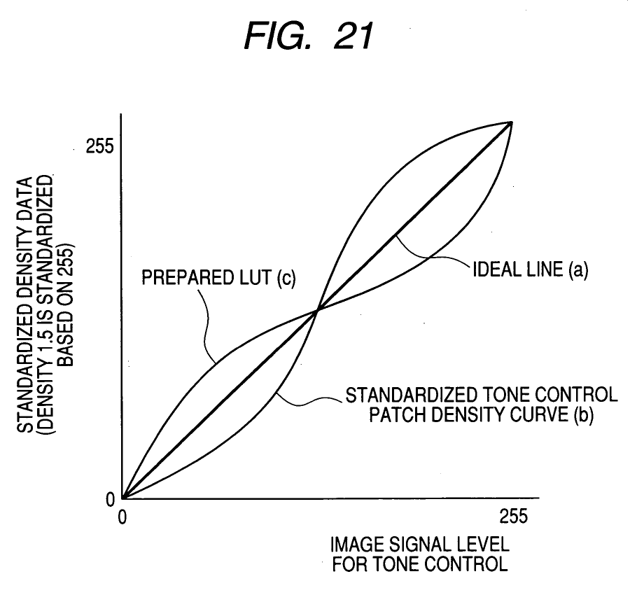

(2) In the image forming apparatus employing the electrophotographic printing method, the γ-characteristic of the image density changes depending on a surrounding environment, the number of used images, or the like. As a result, in particular, in the color image, the change in γ-characteristic appears as a change in color or a tone fluctuation in a highlight portion, resulting in a factor of destabilizing the image formation. Therefore, the electrostatic latent image formed by the image signal for tone correction control is developed to form a patch-patterned toner image (a patch image) as the image for tone correction control. Normally, patch images at a plurality of tone levels are formed. The density of the patch image is detected by the patch sensor 5 in the same manner as described above. Then, by using the detected density information, a lookup table (a γ-LUT) corresponding to tone correction means (information for tone correction) of the γ-converter is prepared again, based on which γ-correction is performed. In this manner, a desired tone characteristic is maintained. Specifically, first, a plurality of patch images are formed. Subsequently, a density of each of the patch images is detected by the patch sensor 5. Then, for example, as shown in FIG. 21, tone correction control is implemented. In FIG. 21, an abscissa axis indicates an image signal level (a tone level) of the patch image, whereas an ordinate axis indicates standardized density data of the patch image. A straight line “a” indicates a target density tone characteristic of image density control (the target density tone characteristic is determined so that the image data and the density have a proportional relation in the example shown in FIG. 21 although it is not limited thereto). A curve “b” represents a density tone characteristic in the state where tone correction control is not implemented, that is, a curve calculated by detecting a plurality of patch images. A curve “c” represents a tone correction table calculated by obtaining a symmetric point of the density tone characteristic b before correction with respect to the target density tone characteristic a. In this manner, for example, the CPU 111 prepares a new γ-LUT (the curve “c”) from the density of each of the patch images which is detected by the patch sensor 5. Then, the CPU 111 stores the prepared new γ-LUT in a storage section provided in, for example, the image processing portion 120 so that the new γ-LUT can be used in the image processing portion 120. Then, in subsequent image formation, γ-correction is performed by using the prepared new γ-LUT to obtain a desired tone characteristic.

The image formation condition that is adjusted for tone correction is not limited to the above-described γ-table. A charging condition of the photosensitive member for forming the electrostatic latent image, a developing condition, or the like may be adjusted instead.

Various methods are known for the developer density control (ATR) or the tone correction control itself described above. Since an arbitrary method can be appropriately employed in the present invention, the further detailed description will be omitted herein.

The patch images can be formed at the start of image formation (print) of an image (an output image) recorded on the recording material P so as to be output, between paper sheets (between images during continuous output image formation), at the end of image formation, or the like.

For example, the patch image corresponding to the image developer density control described above in (1) is formed between paper sheets because it requires a toner supplying operation even during continuous image formation. From the result of detection, feedback is performed. In the case where the recording material P is continuously supplied during continuous image formation, an interval (between paper sheets) required for supplying the recording material P is provided to carry the recording material P to a transfer portion “n” at given intervals. The image forming means forms images in accordance with the given intervals. At this time, the patch image is formed at a position corresponding to that between sheet papers on the photosensitive drum 1. Then, the patch image is transferred onto the transfer belt 61 at the position corresponding to that between sheet papers. In this embodiment, when the patch image transferred to the transfer belt 61 reaches a detection portion by the patch sensor 5, the patch sensor 5 is moved in accordance with it.

At this time, when the patch image as an image for control, which is formed between images (at the position corresponding to that between paper sheets) on the photosensitive drum 1 serving as the first image bearing member or the transfer belt 61 serving as the second image bearing member, is detected by the patch sensor 5 serving as the detecting means, the electrostatic latent image or the toner image of the output image to the photo sensitive drum 1 is formed or the toner image is transferred onto the recording material P onto the transfer belt 61. The timing of formation or transfer is set so as to prevent the detection of the patch image from impeding the image formation.

In order to read a small patch image, it is necessary to slow down an image formation speed or the like in a conventional structure. However, if such an operation is performed between paper sheets, it is necessary to change a set value such as a charging high voltage or a development high voltage or to ensure stabilization time until the speed is stabilized at the speed switching. For such a change or time, it is required to interrupt a job (a series of image forming operations for at least one recording material in response to a single image formation instruction). As a result, downtime (a time period during which an output image cannot be formed) becomes enormous. In contrast with such a conventional structure, the detection position of the patch sensor 5 is movable, so that the image formation speed can be prevented from being lowered and control using a small patch image becomes possible.

The patch image corresponding to the image for tone correction control described in (2) above is normally formed before or after image formation of the output image, or is formed after, during continuous image formation in a long job, the job is interrupted. For example, in the case where the patch image for tone correction control is formed before the image formation, when the image forming control portion (engine control portion) 110 receives an image formation instruction such as copy start, the image forming control portion 110 determines whether the condition for forming the patch image is established or not. Whether the image forming condition is established or not is determined by determining whether a given number of images are formed or not. For example, in the image forming apparatus A according to this embodiment, when 200 or more images are formed, the patch image for tone correction control is formed before image formation. When the patch image formation condition is established, the engine (the image forming portion) first forms the patch image at the start of image formation. Immediately after the formation of the patch image on the photosensitive drum 1 is finished, an image forming operation of the normal output image is performed.

The patch image for tone correction control formed on the photosensitive drum 1 is transferred onto the transfer belt 6, whereas the normal output image is transferred onto the recording material P supplied to the transfer portion “n”. Then, in this embodiment, when-the patch image transferred onto the transfer belt 61 reaches the detection portion by the patch sensor 5, the patch sensor 5 is moved in accordance with it.

Even in the patch image for tone correction control, if the image formation speed is changed for forming a small patch image, the problem of a long downtime occurs as in the case of the formation of the patch image for developer density control described above. Therefore, a first print time (a time period until the first image is formed in response to an image formation start instruction) or a time period for accepting a next job after the completion of a job is prolonged. As a result, user's usability is remarkably degraded. On the other hand, in this embodiment, the detection position of the patch sensor 5 is movable to enable the control with a small patch image without slowing down the image forming speed.

<Method of Moving Patch Sensor>

Next, a method of moving the detection position of the patch sensor 5, which is the most characteristic in this embodiment, will be described.

FIG. 4 is a view showing the patch sensor 5 viewed from a bottom face direction of the transfer belt 61 in FIG. 1. In this embodiment, the detection position of the patch sensor 5 is movable by the moving means 3 along a moving direction of the transfer belt 61 serving as the second image bearing member on which the patch image is formed. In this embodiment, the moving means 3 moves the detection position of the patch sensor 5 in the moving direction of the transfer belt 61 by moving the patch sensor 5 itself.

For further description, in this embodiment, the patch sensor 5 is supported so as to be movable in parallel with the transfer belt 61. The patch sensor 5 is movably held on a rail 30 provided in the same direction as the moving direction (a rotating direction) of the transfer belt 61. The rail 30 is a retaining member for retaining the patch sensor 5 and for regulating the moving direction. The patch sensor 5 is connected to a belt-shaped gear 31.

A first gear 35 for transferring a drive for moving the patch sensor 5 is attached to a drive roller 63 for driving the transfer belt 61. Then, a driving force of the first gear 35 is transferred to a second gear 34 and a third gear (a gear for connection) 32 so as to be ultimately transferred to the belt-shaped gear 31. The first to third gears 35, 34, and 32 and the belt-shaped gear 31 are drive transfer members that transfer a driving force for moving the patch sensor 5 to the patch sensor 5.

An electromagnetic clutch 33 serving as drive switching means is provided between the second gear 34 and the third gear (the gear for connection) 32. As a result, by operating a switch for electromagnetic clutch 33a at a desired timing, the patch sensor 5 can be moved along the transfer belt 61.

As described above, in this embodiment, the drive source of the transfer belt 61 also serves as a drive source for moving the patch sensor 5. Therefore, the moving means for moving the detection position of the patch sensor 5 along the moving direction of the transfer belt 61 includes the drive source of the transfer belt 61, the driving roller 63, the first to third gears 35, 34, and 32, the electromagnetic clutch 33, and the belt-shaped gear 31.

In this embodiment, as described in detail below, a movable distance M of the patch sensor 5 in the moving direction of the transfer belt 61 is set to 50 mm, and a detectable distance “m” of the patch image T in the same direction is set to 30 mm.

When the electromagnetic clutch 33 is turned ON, the driving force of the drive roller 63 is transferred to the belt-shaped gear 61. As a result, the patch sensor 5 moves in a direction indicated by an arrow “f” in FIG. 4, that is, in the same direction as the moving direction of the transfer belt 61 to which the patch sensor 5 is opposed. A spring (not shown) serving as biasing means is provided so that the patch sensor 5 can return to its original position (a home position) “h” when the electromagnetic clutch 33 is turned OFF to apply no driving force. As a result, when the electromagnetic clutch 33 is turned OFF, the patch sensor 5 returns by a spring force in the opposite direction indicated by an arrow “r” in FIG. 4, that is, in the opposite direction to a moving direction R2 of the transfer belt 61 to which the patch sensor 5 is opposed.

The detection position of the developer image detecting means corresponds to an irradiation position of detection light (a light irradiation spot) in the optical sensor. In this embodiment, the position of the patch sensor 5 in the moving direction of the transfer belt 61 is represented by the detection position of the patch sensor 5 in the same direction, that is, a position (its substantial center position) of the light irradiation spot (an LED irradiation spot) S by the light source 50.

In this embodiment, a gear ratio of each of the gears 31, 32, 34, and 35 is set so that the moving speed of the patch sensor 5 becomes the same as that of the transfer belt 61. However, by changing the gear ratio, the speed of the transfer belt 61 and the moving speed of the patch sensor 5 can be varied.

In this embodiment, the patch image T is formed on the transfer belt 61 at a timing corresponding to that between the recording materials P during a series of image forming operations (a job: a series of image forming operations for at least one recording material in response to a single image forming instruction). An interval between paper sheets is 20 mm. A size “t” of the patch image T in the moving direction of the transfer belt 61 is set to 10 mm. Specifically, in this embodiment, a timing of the electromagnetic clutch 33 is created from the patch image formation signal. Specifically, in response to the standard electrostatic latent image signal generated from the standard image generating circuit 114, the CPU 111 generates a signal for turning the switch for electromagnetic clutch 33a ON in synchronization with the generation of a laser driving signal from the pulse width modulating circuit 115. Therefore, the synchronization between the position of the patch image T and the detection position of the patch sensor 5 is sometimes offset by about ±1 mm. The size (diameter) “s” of the light irradiation spot S of the patch sensor 5 in the moving direction of the transfer belt 61 is 5 mm. Therefore, in this embodiment, taking the other margin into consideration, the size “t” of the patch image T in the moving direction of the transfer belt 61 is set to 10 mm.

FIG. 5A shows a locus of the light irradiation spot S on the patch image T, obtained by a conventional patch sensor. Since the patch image T moves in the moving direction of the transfer belt 61 indicated by an arrow R2. The light irradiation spot S on the patch image T moves in a direction indicated by an arrow α (a direction opposite to the moving direction of the transfer belt 61 indicated by the arrow R2) in FIG. 5A in the case where the patch sensor 5 is fixed as in the conventional case. Although the locus of the light irradiation spot S is continuous, circular spots are schematically illustrated in an overlapped manner for easy understanding.

On the other hand, in this embodiment, as shown in FIG. 5B, since the patch sensor 5 moves at the same speed for the movement of the patch image T, the light irradiation spot S does not move with respect to the patch image T. As a result, as shown in FIG. 5B, the size “t” of the patch image T in the moving direction of the transfer belt 61 can be reduced.

As described above, in this embodiment, the movable distance M of the patch sensor 5 is 50 mm, whereas the detectable distance “m” of the patch image T of the patch sensor 5 during movement is set to 30 mm. Specifically, in the moving operation of the patch sensor 5, for the first 10 mm and the last 10 mm, the detection (reading or sampling) of the patch image T is not performed for a fear of shock or the like generated by ON/OFF operations of the electromagnetic clutch.

In this embodiment, since an image formation speed (corresponding to a circumferential speed (a moving speed on a surface) of the photosensitive drum 1 and the transfer belt 61 in this embodiment) of the image forming apparatus A is 200 mm/sec, a readable time corresponding to the detectable distance “m” of the patch sensor 5, m=30 mm, is 150 msec. Therefore, during the readable time, a density of the patch image T is measured. By using the result of measurement, the toner density of the developer in the developing device 4 can be controlled or a desired image parameter such as correction of the tone correction table can be controlled as described in the (1) and/or (2) above as the image forming condition.

For the same control, the size “t” of the patch image in the moving direction of the transfer belt 61 is conventionally required to be about 20 mm. On the other hand, in this embodiment, the size “t” of the patch image can be halved to 10 mm by employing the above-described structure. As a result, the amount of toner consumption for forming the patch image T can be reduced, in this embodiment, can be halved.

Conventionally, when the patch image T having the size “t” of 20 mm in the moving direction of the transfer belt 61 is formed for the same control, the distance between paper sheets of about 30 to 40 mm is normally required in view of various margins. On the other hand, according to this embodiment, the size “t” of the patch image T in the moving direction of the transfer belt 61 can be reduced to 10 mm. Therefore, the distance between paper sheets can be reduced to 20 mm.

Since the image for control such as the patch image T for developer density control or the patch image T for tone correction control is reduced, the detection time of the patch sensor 5 is conventionally reduced to prevent the precise detection. According to this embodiment, however, even if the images for control are small, a sufficiently long detection time can be ensured so as to eliminate the effects of noise on the patch sensor 5 during the detection. As a result, the detected data can be averaged.

In this embodiment, the image formation timing of the patch image T is used to obtain the synchronization between the patch image T and the patch sensor 5. However, the present invention is not limited thereto. For example, a marker such as a white marker tape may be provided on the transfer belt 61. The marker may be sensed with an optical sensor or the like to obtain the timing of moving the patch sensor 5.

Moreover, although the moving means 3 of the patch sensor 5 obtains the driving force through the gears from the drive of the transfer belt 61 in this embodiment, the present invention is not limited thereto. It is apparent that the patch sensor 5 can be moved by another drive means, for example, can be driven by a drive source such as a stepping motor independently of the transfer belt 61.

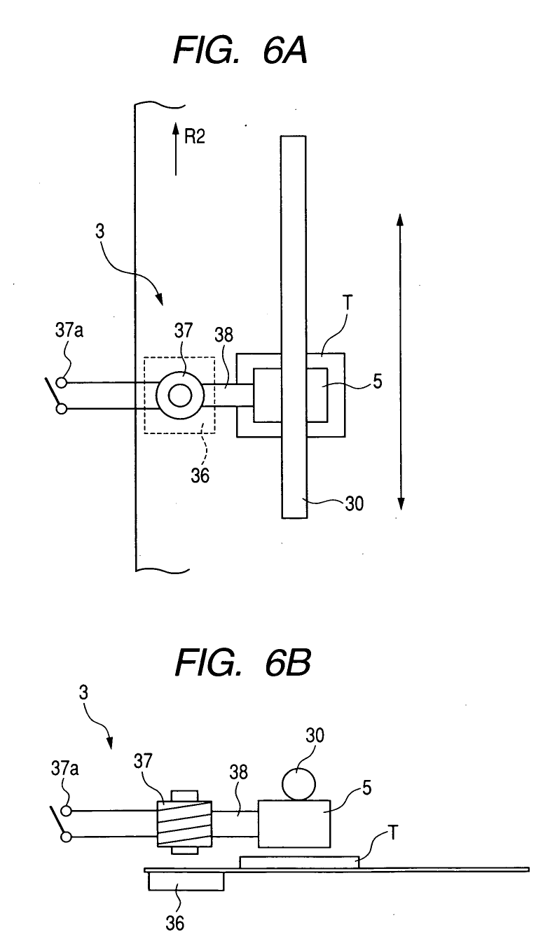

Furthermore, the moving means 3 can also move the patch sensor 5 along the moving direction of the transfer belt 61, for example, with the following structure. FIG. 6A shows the patch sensor 5 viewed from the bottom face of the transfer belt 61 in FIG. 1. FIG. 6B is a sectional view of the patch sensor 5 in a longitudinal direction of the transfer belt 61, viewed along the moving direction of the transfer belt 61. As shown in FIGS. 6A and 6B, a magnetic member 36 made of, for example, Fe—Ni, Mn—Zn ferrite, or the like is attached at a predetermined position on a bottom face of the transfer belt 61 (on the side to which the patch image T is not transferred), so that the patch image T is formed on the surface of the attached position. On the other hand, an electromagnet 37 is provided on the patch sensor 5 side. Specifically, the patch sensor 5 is attached to the electromagnet 37 through a supporting member 38. As the moving means 3 shown in FIG. 4, the patch sensor 5 is movably retained by the rail 30. Then, when the patch image T gets to the detection position of the patch sensor 5, a switch 37a for electromagnet is turned ON so as to supply power to the electromagnet 37. In this manner, the patch sensor 5 is held (retained) at a predetermined position on the transfer belt 61 so as to be moved in the same direction as the moving direction R2 with the movement of the transfer belt 61.

As described above, according to this embodiment, the patch sensor 5 is provided to be moved in the moving direction of the transfer belt 61 bearing the patch image T. The patch sensor 5 is moved with the movement of the patch image T so as to detect the patch image T, thereby enabling the reduction of the size of the patch image T. As a result, an area where the patch image T is formed, for example, the distance between paper sheets can be reduced. Moreover, it is possible to increase the number of patch images with a reduced control time or during the same time period. Furthermore, since the size of the patch image T can be reduced, the amount of toner consumption can be reduced with the reduction in size. Moreover, according to this embodiment, even if the image for control such as the patch image T for developer density control or the patch image T for tone correction control is small, a sufficiently long detection time of the patch image T can be ensured so as to enable precise detection of the image for control.

### SECOND EMBODIMENT

Next, another embodiment of the present invention will be described. Fundamental structure and operation of the image forming apparatus according to this embodiment are the same as those in the first embodiment. Therefore, elements having substantially the same functions and structure as or corresponding functions and structure to those of the first embodiment are denoted by the same reference numerals, and the detailed description thereof is herein omitted.

In this embodiment, the case where a difference is provided between the moving speed of the transfer belt 61 and the moving speed of the detection position of the patch sensor 5 will be described. As in the first embodiment, in the second embodiment, the moving means 3 moves the patch sensor 5 itself to move the detection position of the patch sensor 5 along the moving direction of the transfer belt 61.

In this embodiment, in particular, the case where the patch image (also referred to as a “tone patch” below in this embodiment) T corresponding to the image for tone correction control is formed so as to be detected by the patch sensor 5 to perform tone correction control (correction control of the γ-LUT) will be described. However, this embodiment is not limited thereto. This embodiment can also be applifed to the case where the patch image is formed as the image for developer density control to be detected as described above.

In the tone correction control with the tone patch T (patch detection tone control), a plurality of patch images T at different densities are normally formed, so that the densities are detected by the patch sensor 5. Then, the γ-LUT is corrected to obtain an appropriate tone characteristic.

Generally, in the control correction control with the tone patch T, as the number of tone patches becomes larger, that is, the tone patches T at a larger number of tone levels are formed to be detected, control can be performed with higher accuracy. However, if the number of the tone patches T is increased, the control time is prolonged to increase the downtime of the image forming apparatus. Therefore, there is a fear that the usability of the image forming apparatus may be degraded. Moreover, if the number of the tone patches T is increased, there is a fear that the amount of toner consumption is increased. Accordingly, about five to eight tone patches T are conventionally used for control in many cases.

In this embodiment, the tone patches T have sixteen tones. Specifically, sixteen patch images are formed. This increase in the number of tones can be realized by reducing the size of each of the tone patches T in the moving direction of the transfer belt 61 to allow the number of tone patches to be increased.

In this embodiment, the moving means 3 of the patch sensor 5 sets the moving speed of the patch sensor 5 to half of the moving speed of the transfer belt 61, that is, 100 mm/sec. In this regard, the moving means 3 in this second embodiment differs from that in the first embodiment.

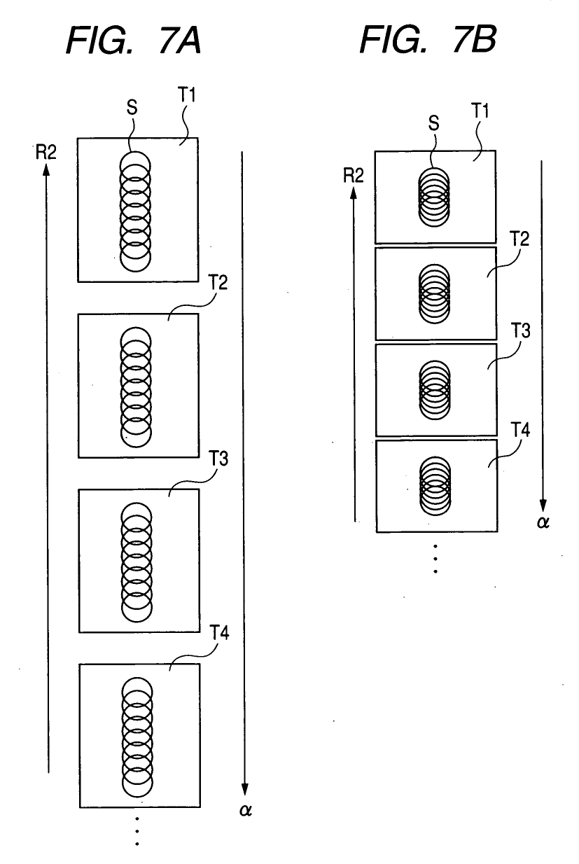

FIG. 7A schematically shows the movement of the light irradiation spot S from the patch sensor 5 on the conventional tone patches T. In this embodiment, sixteen tone patches T are formed as described above. However, FIGS. 7A and 7B schematically show only the first to fourth tone patches T1 to T4, and the other tone patches T are omitted herein.

Conventionally, the patch sensor 5 detects the tone patch T in a fixed state for the movement of the tone patch T in the direction indicated by an arrow R2 in FIG. 7A caused by the movement of the transfer belt 61. As a result, the light irradiation spot S moves in the direction indicated by an arrow α in FIG. 7A (in the opposite direction to the moving direction of the transfer belt 61 indicated by the arrow R2 in FIG. 7A). Therefore, it is necessary to set the relatively large size “t” of the each tone patch T in the. moving direction of the transfer belt 61 so as to ensure a predetermined read time.

On the other hand, in this embodiment, the patch sensor 5 is moved by the moving means 3. The moving speed of the patch sensor 5 is set to half of the moving speed of the transfer belt 61. In this case, as shown in FIG. 7B, the light irradiation spot S moves in the direction indicated by the arrow α in FIG. 7B (in the opposite direction to the moving direction of the transfer belt 61 indicated by the arrow R2 in FIG. 7B). However, even if reading is performed during the same time period as that in the conventional example, the amount of movement of the light irradiation spot S is smaller than that of the conventional case shown in FIG. 7A. Therefore, the size “t” of each tone patch T in the moving direction of the transfer belt 61 can be reduced as compared with the conventional one. Herein, the detection position of the patch sensor 5, that is, the light irradiation spot S sequentially moves from a patch image T1 at the head in the moving direction of the transfer belt 61 to a next patch image T2 (in the same manner for the subsequent patch images) while moving in the same direction as that of the transfer belt 61, whereby the patch sensor 5 sequentially detects the patch images T.

Therefore, according to this embodiment, the control time for tone correction control can be reduced. Moreover, since the size of each tone patch can be reduced, the amount of toner consumption can be reduced. Alternatively, the tone correction control can be performed by using a larger number of tone patches, that is, the tone patches at a larger number of tone levels without increasing the downtime of the image forming apparatus.

Moreover, in this embodiment, by providing a difference between the moving speed of the transfer belt 61 and the moving speed of the patch sensor 5, the patch sensor 5 can detect a larger area in the moving direction of the transfer belt 61 as compared with the first embodiment. Accordingly, the effect of reducing an error in the case where a part of the patch image has a defect can also be obtained.

Furthermore, in this embodiment, the detection position of the patch sensor 5 (the patch sensor 5 itself in this embodiment) is set to move at a half speed of the moving speed of the transfer belt 61. However, the difference in speed between the transfer belt 61 and the detection position of the patch sensor 5 in the present invention is not limited thereto. The difference in speed can be appropriately selected in view of the effect of reducing the size of the patch image T, the effect of reducing an error by enlarging the detection area described above, and the like. According to the examination of the inventor of the present invention, it is normally preferred that the moving speed of the detection position of the patch sensor 5 is set to ¼ of the moving speed to the same speed (the normal speed) as the moving speed of the transfer belt 61 (the first embodiment). If the difference in speed becomes larger to exceed the above range (specifically, the moving speed of the patch sensor 5 is further reduced), the effect of reducing the size of the patch image T decreases.

Although the patch sensor 5 is set to always move at the same speed in this embodiment, a structure of variably setting the moving speed of the patch sensor 5, for example, using a stepping motor as the driving means, can also be used.

For example, the speed can be switched based on a mode. For example, in a plain paper mode, the speed can be set to a half speed. In a high quality image mode such as for coated paper, the speed can be set to the normal speed.

In the case where a plurality of patch images T such as the tone patches T ate detected, the difference in speed between the patch sensor 5 and the transfer belt 61 can be reduced when the patch image T is read and can be then increased when the patch sensor 5 is moved to a next patch for quick movement and the like. Specifically, for example, when the first patch image T is read, the patch sensor 5 is moved at the same speed as that of the transfer belt 61. When the patch sensor 5 is moved to the second patch image T, the movement of the patch sensor 5 is stopped, so that the patch sensor 5 restarts moving at the same speed as that of the transfer belt 61 in the area of the second patch image T.

Alternatively, after a read start position of the patch image T is determined so as to read the first patch image T, the patch sensor 5 is returned to the read start position between the patch images. Then, for reading the second patch image T, the patch sensor 5 may restart moving at the same speed as that of the transfer belt 61. Specifically, the patch sensor 5 may return to the home position “h” (FIG. 4) each time each of the tone patches T is detected. Subsequently, a next tone patch T may be detected.

According to this embodiment, as described above, the same effect as that of the first embodiment can be obtained. At the same time, the difference in speed is provided between the moving speed of the detection position of the patch sensor 5 and the moving speed of the transfer belt 61. As a result, the detection area of the patch image T is increased as needed so as to obtain the effect of reducing a read error by the patch sensor 5 and the like.

### THIRD EMBODIMENT

Next, another embodiment of the present invention will be described. Fundamental structure and operation of the image forming apparatus according to this embodiment are the same as those in the first embodiment. Therefore, elements having substantially the same functions and structure as or corresponding functions and structure to those of the first embodiment are denoted by the same reference numerals, and the detailed description thereof is herein omitted.

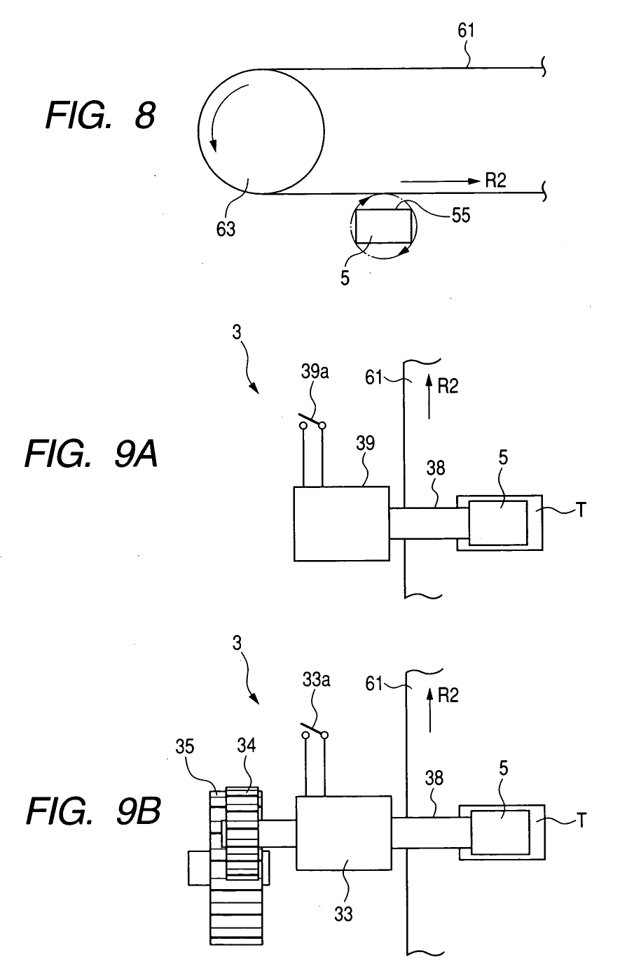

In this embodiment, as shown in FIG. 8, the patch sensor 5 is rotatable so as to move along the moving direction of the transfer belt 61 in the area opposed to the transfer belt 61. In this embodiment, a rotational axis of the patch sensor 5 approximately and perpendicularly crosses the moving direction of the transfer belt 61. In this manner, the detection position of the patch sensor 5 moves along the moving direction of the transfer belt 61.

Specifically, in this embodiment, as shown in FIG. 9A, the moving means 3 of moving the detection position of the patch sensor 5 in the moving direction of the transfer belt 61 has a stepping motor (driving means or a drive source) 39 as rotating means. As a result, the patch sensor 5 is rotatably driven by the stepping motor 39. Specifically, the patch sensor 5 is fixed to a rotational shaft of the stepping motor 39 through the rotational shaft 38 corresponding to the retaining member. The CPU 111 rotates the stepping motor 39 at a predetermined timing at a predetermined speed to rotate the patch sensor 5. The number of revolutions of the patch sensor 5 caused by the stepping motor 39 can be set so that a detection surface 55 of the patch sensor 5 (a surface on the side where the detection light is radiated, and in a direction crossing (in this embodiment, approximately perpendicularly crossing) the irradiation direction of the detection light), that is, the detection position (the light irradiation spot S) of the patch sensor 5 can track the patch image T.

The patch sensor 5 may be continuously rotated in synchronization with the movement of the transfer belt 61 or intermittently rotated with the passage of the patch images T during a predetermined time period for developer density control, tone correction control, or the like. The rotation of the patch sensor 5 is not necessarily limited to the full rotation about the rotational axis. A mode, in which the patch sensor 5 pivots while reciprocating within a predetermined rotation angle range, also falls within the scope of the present invention.

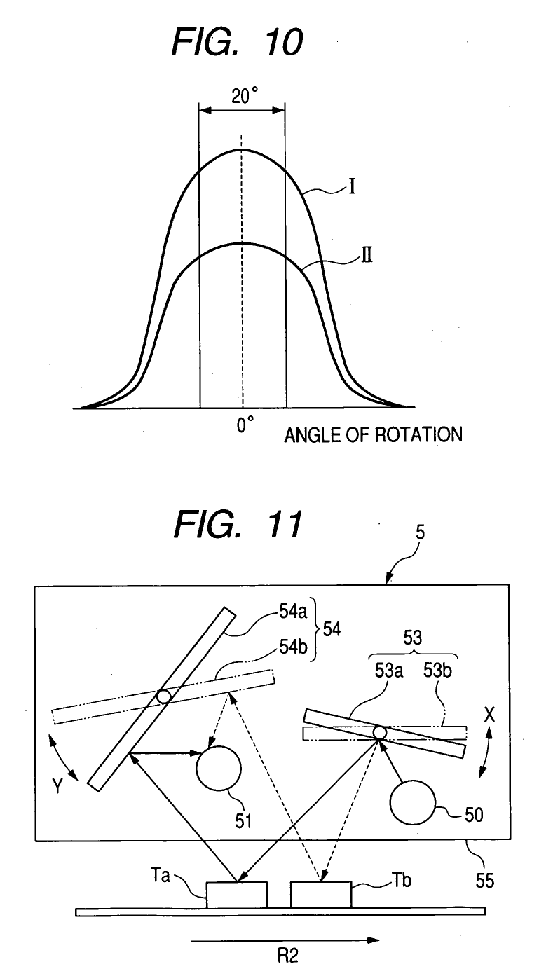

FIG. 10 schematically shows a change in output when the patch sensor 5 is rotated while facing the patch image T. In this embodiment, a distance between the detection surface 55 of the patch sensor 5 and the surface of the transfer belt 61 is set to 5 mm when they are parallel to each other. In this embodiment, the position of the patch sensor 5 at this time, that is, the position at which the patch sensor 5 and the transfer belt 61 face each other (a facing position) is at 0°. An output from the patch sensor at this position is 100% (a peak value). In this embodiment, when the patch sensor 5 is rotated at about 10° in the rotating direction, an output from the patch sensor 5 is about 90% with respect to the peak value. Even if the amount of toner on the transfer belt 61, that is, the density of the patch image T changes, outputs in similar profiles as curves I and II in FIG. 10 are obtained. As a result, in this embodiment, the patch sensor 5 detects the density by using an integrated value of the outputs from −10° to +10°, that is, within the range of 20°.

Specifically, the range of the angle of rotation detectable by the patch sensor 5 is not limited to that in this embodiment. The range of the angle of rotation can be appropriately selected in view of the relation with the detection accuracy and the like. According to the examination by the inventor of the present invention, a good result can be obtained by integrating the peak value of the output when the transfer belt 61 and the patch sensor 5 are at the above-mentioned facing position by an output within the range of 80% to 100%.

In this embodiment, a moving distance of the light irradiation spot S on the surface of the transfer belt 61 is about 2 mm when the angle of rotation of the patch sensor 5 is 20°. While the light spot S moves by 2 mm, the surface of the patch image T is set to move by 4 mm. Specifically, in this embodiment, the moving speed of the patch sensor 5 is set to half of the speed of the transfer belt 61. The rotation time of the patch sensor 5 is 20 msec for the rotation at 20°. It is apparent that the difference in speed between the moving speed of the transfer belt 61 and that of the detection position of the patch sensor 5 may be another value as described above in the first and second embodiments. Alternatively, the moving speed of the transfer belt 61 and that of the detection position of the patch sensor 5 may be set approximately equal to each other. This structure can be achieved by providing a difference in speed between the rotating speed of the patch sensor 5 by the rotating means and the moving speed of the transfer belt 61 or by setting both the speeds equal to each other.

According to this embodiment, with the above-described structure, the size of the patch image T in the moving direction of the transfer belt 61 can be reduced to about half of the conventional size. As a result, the area for forming the patch, for example, the distance between paper sheets can be reduced. Moreover, the amount of toner consumption can be halved.

Although the patch sensor 5 is rotatably driven by the stepping motor 39 in this embodiment, the present invention is not limited thereto. For example, as shown in FIG. 9B, approximately the same structure of driving the patch sensor 5 in the first embodiment may be provided. By transferring the drive of the transfer belt 61 through the first and second gears 34 and 35, the electromagnetic clutch 33 and the rotational axis 38, the same effect can be obtained.

### FOURTH EMBODIMENT

Next, another embodiment of the present invention will be described. Fundamental structure and operation of the image forming apparatus according to this embodiment are the same as those in the first embodiment. Therefore, elements having substantially the same functions and structure as or corresponding functions and structure to those of the first embodiment are denoted by the same reference numerals, and the detailed description thereof is herein omitted.

In this embodiment, moving means for moving the detection position of the patch sensor 5 along the moving direction of the transfer belt 61 is provided as an internal structure of the patch sensor 5. In this embodiment, the detection light radiated from the light source 50 of the patch sensor 5 corresponding to the optical sensor is deflected so as to move the detection position of the patch sensor 5 along the moving direction of the transfer belt 61. Specifically, a traveling direction of light emitted from the light source 50 fixed at a predetermined position is changed so as to move the detection position.

FIG. 11 is a schematic configuration view of the patch sensor 5 used in this embodiment. In the patch sensor 5, a light emitting diode (an LED) 50 corresponding to a light source, a photodiode (a PD) 51 corresponding to a light-emitting element for density measurement, which receives reflected light, an irradiated light guiding mirror (a mirror for an optical path change) 53 (subscripts “a” and “b” in FIG. 11 indicate a status of position) corresponding to irradiation optical path changing means for guiding the irradiated light from the LED 50 to the patch image T corresponding to a target, and a reflected light guiding mirror (a mirror for an optical path change) 54 (subscripts “a” and “b” in FIG. 11 indicate a status of position) corresponding to received light optical path changing means for guiding the reflected light from the path image T to the photodiode 51 are provided.

The irradiated light guiding mirror 53 is rotatable in a direction indicated by an arrow X in FIG. 11, for example, as indicated by a first position 53a and a second position 53b in FIG. 11. The irradiated light from the LED 50 is guided to a desired position of the patch image T on the transfer belt 61 so as to be radiated thereon. Similarly, the reflected light guiding mirror 54 is rotatable in a direction indicated by an arrow Y in FIG. 11 so that a regular reflected light of the irradiated light on the patch image T is incident on approximately the center of the photodiode 51. In this embodiment, the moving means for moving the detection position of the patch sensor 5 along the moving direction of the transfer belt 61 includes a stepping motor for rotatably driving the irradiated light guiding mirror (a reflecting member) 53 and the reflected light guiding mirror (a reflecting member) 54 as rotating means. Specifically, in this embodiment, the rotating means rotates the irradiated light guiding mirror 53 and the reflected light guiding mirror 54 about the rotational axis approximately and perpendicularly crossing the moving direction of the transfer belt 61 to deflect the detection light and to radiate the reflected light onto the light receiving element for density measurement. As a result, the detection position of the patch sensor 5 can be moved along the moving direction of the transfer belt 61.

As in the third embodiment, the rotating means may pivot the irradiated light guiding mirror 53 and the reflected light guiding mirror 54 about the rotational shaft while reciprocating in a predetermined range or may fully rotate the irradiated light guiding mirror 53 and the reflected light guiding mirror 54. Alternatively, the irradiated light guiding mirror 53 and the reflected light guiding mirror 54 may be continuously rotated in synchronization with the movement of the transfer belt 61 or may be intermittently rotated with the passage of the patch images T during a predetermined time period for developer density control, tone correction control, or the like.

For further description, the patch image T is borne on the transfer belt 61 and is moved along the traveling direction R2 of the transfer belt 61. For example, when the patch image T is at a position Ta in FIG. 11, the irradiated light guiding mirror 53 is set at the first position 53a whereas the reflected light guiding mirror 54 is set at the first position 54a. Then, as the patch image T moves toward a position Tb in FIG. 11, the irradiated light guiding mirror 53 rotates to the second position 53b whereas the reflected light guiding mirror 54 rotates to a second position 54b so as to track the movement of the patch image T.

In the patch sensor 5 of this embodiment, the irradiated light guiding mirror 53 is 3 mm in the moving direction of the transfer belt 61 and 3 mm in a direction vertical to the moving direction of the transfer belt 61. The reflected light guiding mirror 54 is 6 mm in the moving direction of the transfer belt 61 and 5 mm in a direction vertical to the moving direction of the transfer belt 61.

As described in the embodiment above, the moving speed of the detection position of the patch sensor 5 may be equal to that of the transfer belt 61, or a difference may be provided therebetween. This is realized by setting the rotating speed of the irradiated light guiding mirror 53 and the reflected light guiding mirror 54 by the rotating means equal to the moving speed of the transfer belt 61 or by providing a difference therebetween.

In this embodiment, each of the irradiated light guiding mirror 53 and the reflected light guiding mirror 54 is a planar mirror. Although a planar mirror is used in this embodiment, a light collecting characteristic for the irradiated light and the reflected light is improved by providing a curvature for a reflected surface as a concave mirror or the like so as to further improve a sensor sensitivity.

In this embodiment, the mirrors 53 and 54 are rotatably driven by using a stepping motor as the rotating means in the same manner as in the case where the patch sensor 5 is rotatably driven in the third embodiment. In the same manner in which the patch sensor 5 is rotatably driven by transferring the drive of the transfer belt 61 in the third embodiment, the mirrors 53 and 54 can also be rotated through the gears from the drive of the main body.

According to this fourth embodiment, with the above-described structure, the patch can be tracked by using the sensor alone. The size of the patch sensor 5 in the image forming apparatus main body 100 can be reduced in addition to the reduction of the size of the patch image T in the moving direction of the transfer belt 61. As a result, the structure of the image forming apparatus main body 100, in which the patch sensor 5 is provided, can be simplified.

### FIFTH EMBODIMENT

In this embodiment, an optical deflector, which can be used as the driving means of the irradiated light guiding mirror 53 and the reflected light guiding mirror 54 corresponding to the optical path changing means (the irradiated light optical path changing means and the received light optical path changing means), in the patch sensor 5 described in the fourth embodiment will be described. According to a driving method of this embodiment, the irradiated light guiding mirror 53 and the reflected light guiding mirror 54 of the patch sensor 5 can be rotated by a smaller driving structure.

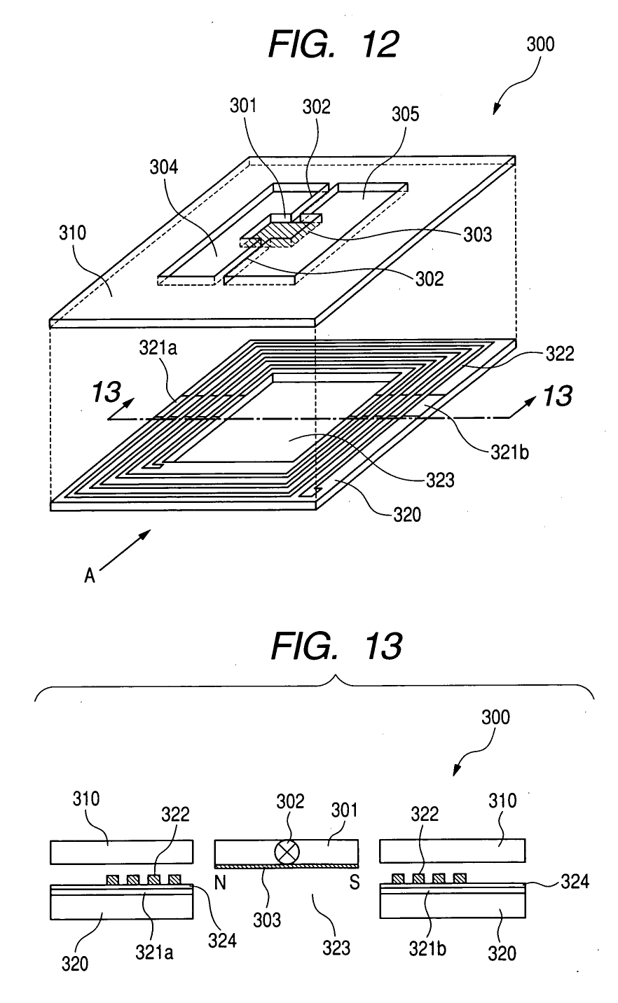

FIG. 12 is an exploded view of an optical deflector 300 according to this embodiment. FIG. 13 is a sectional view taken along a line B-B viewed from a direction indicated by an arrow A in FIG. 12. The optical deflector 300 in this embodiment includes a support substrate (a first substrate) 310 and a second substrate 320. A movable plate 301 is supported by an elastic supporting portion 302 corresponding to a pair of torsion springs extending in a uniaxial direction on the support substrate 310 shown in the upper part of FIG. 12. The elastic supporting portion 302 functions as a movable shaft (a rotational shaft) of the movable plate 301. On an upper face of the movable plate 310 in FIG. 12, mirror surfaces (not shown) are provided. On its bottom face in FIG. 12, a hard magnetic film 303 is provided. The mirror surfaces function as the irradiated light guiding mirror 53 and the reflected light guiding mirror 54. The hard magnetic film 303 is magnetized in plane in a direction perpendicularly crossing an axial direction of the elastic supporting portion 302 so as to be a permanent magnet. Therefore, an N or S magnetic pole appears on the side of the movable plate 301 where the elastic supporting portion 302 is not provided. FIG. 13 shows a magnetized state of the permanent magnet (the hard magnetic film) 303 of the movable plate 301. Specifically, in this embodiment, the movable plate 301, that is, both ends of the movable plate 301 in the direction perpendicularly crossing the movable shaft of the mirror surface are magnetized so that the N-magnetic pole or the N-magnetic pole appears on each of the ends. On the second substrate 320, fixed cores 321a and 321b and a planar coil 322 formed on the fixed cores 321a and 321b through an insulating film 324 are provided.

The optical deflector 300 in this embodiment can be manufactured by the following method. The support substrate 310, the movable plate 301 and the elastic supporting portion 302 are formed by etching a single-crystalline silicon substrate to provide two openings 304 and 305 as shown in FIG. 12. As a result, the support substrate 310, the movable plate .301 and the elastic supporting portion 302 are made of integral single-crystalline silicon to obtain a vibration system having a large Q value. The mirror surface is formed by depositing aluminum on a surface of the movable plate 301 by an electron beam evaporation method. The hard magnetic film 303 is formed by bonding a segment of a permanent magnet made of Fe—Co—Cr onto a bottom surface of the movable plate 301.

As the second substrate 320, a silicon substrate including a silicon dioxide film formed by thermal oxidation is used. First, on the second substrate 320, soft magnetic films made of Fe—Ni (a permalloy) serving as the fixed cores 321a and 321b in a predetermined pattern are formed by plating. Next, a silicon dioxide film serving as an insulating thin film 324 is formed on the soft magnetic films 321a and 321b by sputtering corresponding to one of vacuum evaporation methods. Thereafter, after copper is deposited on the insulating thin film 24 by sputtering, a photoresist is applied. After exposure to light and development, the silicon dioxide film is patterned by ion milling using an Ar gas to form the planar coil 322. Subsequently, the bottom face of the second substrate 320 is dry etched to provide a window portion 323.

Thereafter, the upper support substrate 310 and the lower support substrate (the second substrate) 320 are connected to each other in a predetermined size to form the optical deflector 300 according to this embodiment. When the optical deflector 300 is shown in its cross section as shown in FIG. 13, the movable plate 301 is provided in the window portion 323 of the second substrate 320 while surrounded by the planar coils 322 provided on the second substrate 320 around the window portion 323. Then, both the ends (the right and left ends in FIG. 13) of the movable plate 301 in the direction perpendicularly crossing the axial direction of the elastic supporting portion 302, that is, the magnetic poles of the hard magnetic film 303 in this direction comes close to the inner end faces of the planar coils 322.

Hereinafter, the principle of operation of the optical deflector 300 will be described, taking a typical example of the optical deflector 300 as an example. The optical deflector 300 in this example can be manufactured by using a micromachining technique. As described above, the optical deflector 300 typically includes: the movable plate 301 having the mirror and the hard magnetic film 303; the planar coils 322; the fixed cores 321a and 321b made of a soft magnetic film, which are arranged along the planes of the planar coils 322; and the elastic supporting portion 302 for rotatably supporting the movable plate 301 with respect to the support substrate 310.

The principle of drive in this typical example is as follows. The principle of drive when the optical deflector 300 is used as drive means (a rocking member device) of the irradiated light guiding mirror 53 and the reflected light guiding mirror 54 of the patch sensor 5 described in the fourth embodiment is substantially the same as the following principle.

The hard magnetic film 303 of the movable plate 301 is magnetized in a direction at a right angle to a rocking shaft (the elastic supporting portion) so that its ends have S and N magnetic poles, respectively. A current flowing through the planar coils 322 generates magnetic fields having the same magnetic polarity and the same magnitude at two ends of the fixed cores (the soft magnetic films) 321a and 321b, which are closer to the movable plate 301. Two magnetic poles of the movable plate 301 react against the magnetic fields to generate a torque around the axis of the elastic supporting portion 302 to rotate the movable plate 301. If the current flowing through the planar coils 322 is an alternate current, the movable plate 301 including the mirror rocks in predetermined cycles to allow the oscillation and deflection of light radiated on the mirror.

In the above-described structure, if the planar coil 322 is formed as a thin film, the entire apparatus has a smaller thickness. However, if the same number of turns of a stereoscopic coil is to be realized by the planar coils, a large area is required in a horizontal direction. In this typical example, in order to resolve this dilemma, the fixed cores 321a and 321b, each being made of a soft magnetic film, are provided, thereby obtaining the following advantages.

The first advantage is that a large optical deflection angle (a large angle of rotation of the movable plate) can be realized because a large magnetic field is generated. The second is that a predetermined magnetic field can be obtained at a lower current to realize the reduction in power consumption. The third is that the reduction in size can be realized because a predetermined magnetic field.can be obtained with a fewer turns of the coil.

For the introduction of the fixed cores (the soft magnetic films) 321a and 321b, the arrangement of the planar coils 322, the hard magnetic film 303 and the soft magnetic films 321a and 321b is important. Generally, if the soft magnetic films are provided close to the coils, the magnetic poles are generated on the ends of the soft magnetic films to create a large magnetic field. However, since the effect of concentrating a magnetic field distribution is degraded in some arrangements, an optimal structure is required.

In the arrangement in this typical example, the surface, on which both magnetic poles are formed by the hard magnetic films 303, is arranged in a direction of the side of the surface, on which the planar coils 322 are formed, with respect to the surface on which the soft magnetic films 321a and 321b are formed, or is arranged in a plane approximately identical with the surface on which the soft magnetic films 321a and 321b are formed. This arrangement corresponds to the following three arrangements. In the first arrangement, the surface, on which the planar coils 322 are formed, is arranged between the surface on which the soft magnetic films 321a and 321b are formed and the surface on which both magnetic poles are formed by the hard magnetic film 303. In the second arrangement, the surface, on which both magnetic poles are formed by the hard magnetic film 303, is arranged between the surface on which the soft magnetic films 321a and 321b are formed and the surface on which the planar coils 322 are formed. In the third arrangement, the surface on which the soft magnetic films 321a and 321b are formed is in approximately the same plane as the surface on which both magnetic poles are formed by the hard magnetic film 303.

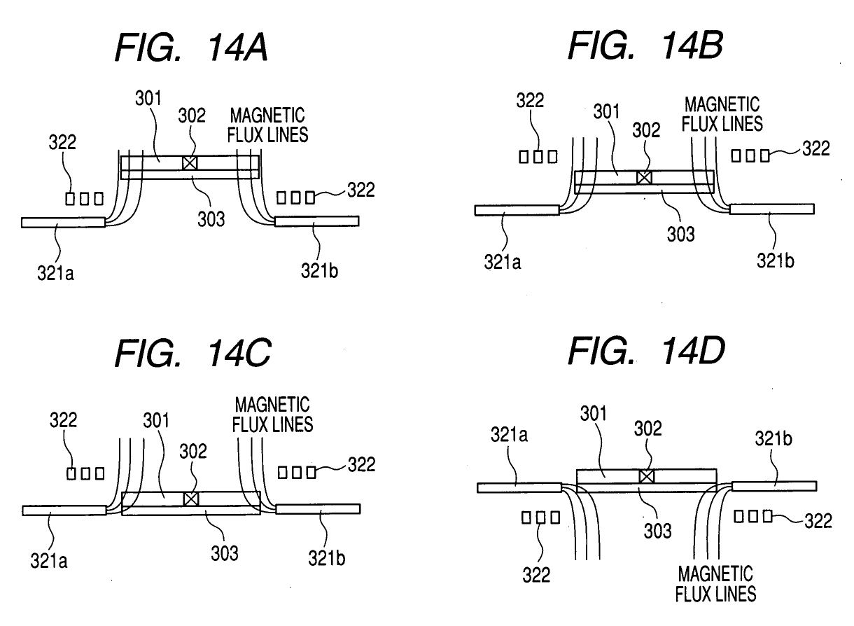

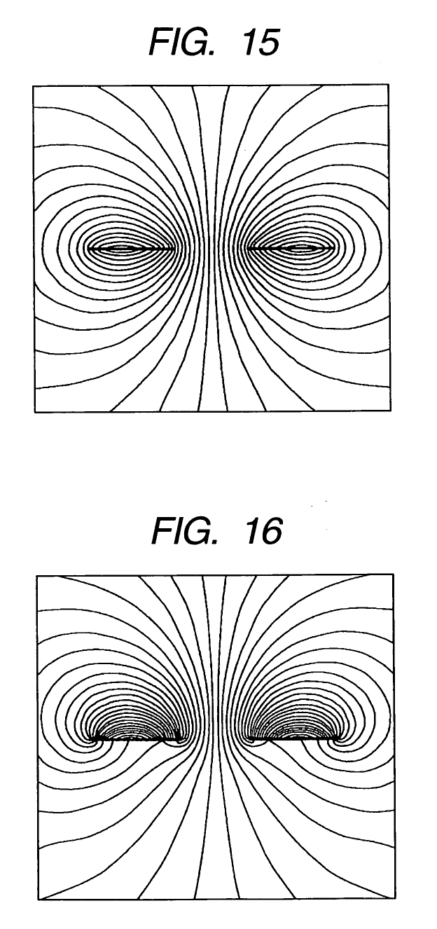

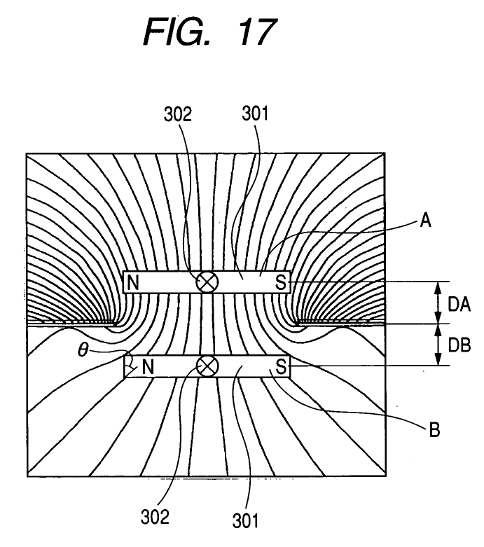

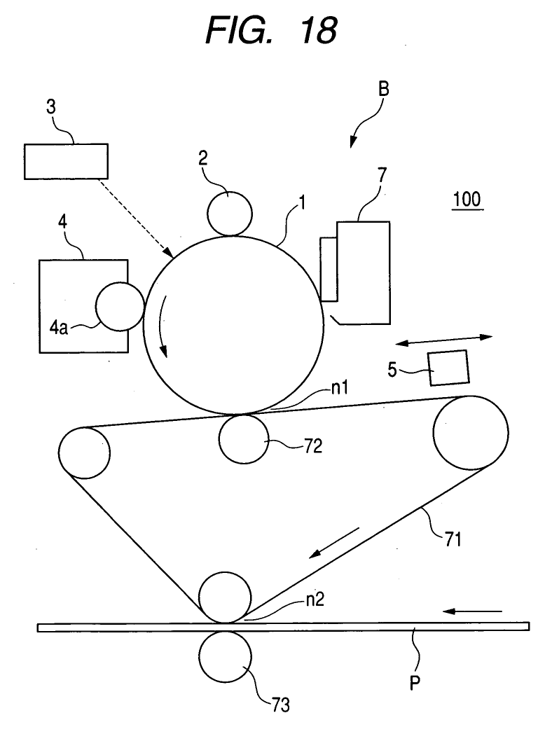

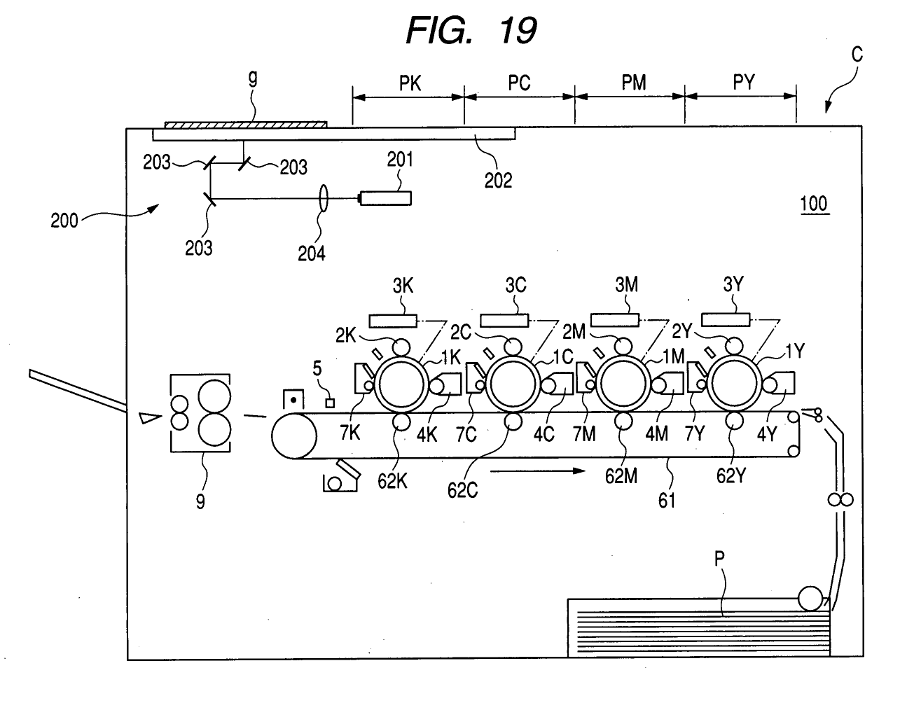

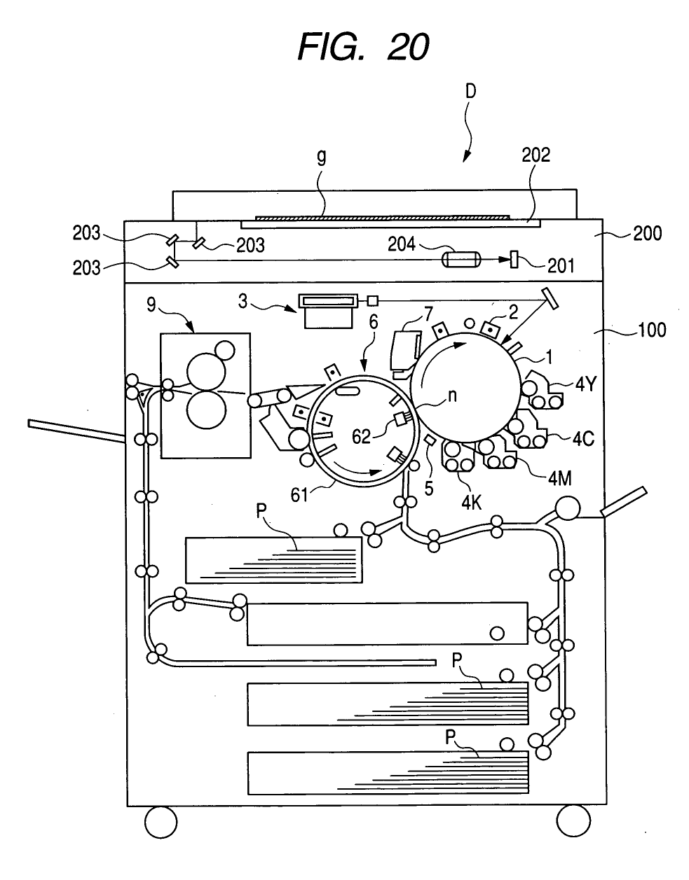

With reference to FIGS. 14A, 14B, 14C, and 14D, the arrangement of the planar coils 322, the hard magnetic film 303 and the soft magnetic films 321a and 321b in this typical example will be further described. Herein, the planar coils 322 surround the movable plate 301. However, only a cross section is shown in each of FIGS. 14A to 14D. Moreover, FIGS. 14A to 14D schematically show a part of magnetic flux lines emitted from the movable plate 301, the elastic supporting portion 302 and the soft magnetic films 321a and 321b. A more detailed magnetic flux line diagram will be described as an example of a simulation described below.

FIG. 14A illustrates the first arrangement described above, FIG. 14B illustrates the second arrangement described above, and FIGS. 14C and 14D illustrate the third arrangement described above.

Referring to FIG. 14A, a large magnetic field corresponding to dense magnetic flux lines is generated on the end of each of the soft magnetic films 321a and 321b. The magnetic flux lines travel up toward the position where the planar coils 322 are arranged. Both the magnetic poles formed by the hard magnetic film 303 provided for the movable plate 301 are subjected to the large magnetic filed in the direction perpendicularly crossing the hard magnetic films 321a and 321b when the magnetic poles are on the side of the planar coils 322 with respect to the soft magnetic films 321a and 321b. As a result, the movable plate 301 obtains a large rotational torque. This is also applied to the arrangement shown in FIG. 14B. An effective arrangement for obtaining a large rotational torque by both the magnetic poles formed by the hard magnetic film 303 and the soft magnetic films 321a and 321b is realized as long as both the magnetic poles and the soft magnetic films 321a and 321b are arranged in the approximately identical plane. If the faces of the both magnetic poles formed by the hard magnetic film 303 are arranged out of the identical plane at the position opposite to the planar coils 322 regarding the surface as a reference surface, on which the soft magnetic films 321a and 321b are formed, the magnetic fields at both the magnetic poles are conversely reduced. Therefore, the arrangements showing a limit for obtaining a large rotational torque are as shown in FIGS. 14C and 14D.

When the soft magnetic films 321a and 321b are provided at the positions close to both magnetic poles formed by the hard magnetic film 303, a large force acts on each of the both magnetic poles. However, if a direction of the force is offset from the direction of rotation of the movable plate 301, a component contributing to the movement becomes smaller. Therefore, the arrangements shown in FIGS. 14A and 14B, in which a component of the magnetic field perpendicularly crossing the direction connecting both magnetic poles formed by the hard magnetic film 303 with each other becomes larger, are preferred. As a result, the small optical deflector 300 having a large angle of deflection with less power consumption can be configured.

The optical deflector 300 shown in FIG. 14A can be manufactured with, for example, a support substrate for supporting the movable plate 301 and the elastic supporting portion 302 and one substrate on which the planar coils 322 and the soft magnetic films 321a and 321b are formed. When the optical deflector 300 shown in FIG. 14B is to be manufactured, three substrates, that is, a support substrate for supporting the movable plate 301 and the elastic supporting portion 302, a substrate on which the planar coils 322 are formed, and a substrate on which the soft magnetic films 321a and 321b are formed are required. In view of the number of required substrates, it is believed that the most preferred arrangement is the arrangement shown in FIG. 14A where the soft magnetic films 321a and 321b, the planar coils 322 and the hard magnetic film 303 are arranged in this order.

The movable plate 301 may have the hard magnetic film 303 magnetized in the same direction on either or both of the surfaces. In order to increase a generated force for rocking the movable plate 301, at least one of the hard magnetic films 303 is required to satisfy the relation of arrangement described.

The soft magnetic films 321a and 321b and the planar coils 322 can be formed on the support substrate 310 that supports the movable plate 301. Moreover, the soft magnetic films 321a and 321b and the planar coils 322 may be formed on a surface of the second substrate 320, which is arranged to be opposed to the support substrate 310 that supports the movable plate 301 (FIGS. 12 and 13). When the second substrate 320 is used, it is suitable to provide the window portion or concave portion 323 at the position opposed to the movable plate 301. The formation of the window portion or the concave portion 323 corresponding to a hole passing through the second substrate 320 provides the following two advantages. The first advantage is that the movable plate 301 does not come into contact with the second substrate 320 when the movable plate 301 is displaced by torsional rotation. The second advantage is that air dumping is prevented from being formed between the movable plate 301 and the second substrate 320 when the movable plate 301 is displaced, thereby preventing the Q-value of the vibrating system from being lowered. If the window portion is provided, deflected light can be radiated through the window portion as an additional advantage.

The elastic supporting portion 302 of the movable plate 301 can also be made of single-crystalline silicon. The single-crystalline silicon is a material that is easily available and excellent in mechanical characteristics (that is, excellent in physical strength, durability and lifetime for its relatively light weight). By using single-crystalline silicon as a material of the elastic supporting portion 302, an attenuation coefficient of the elastic supporting portion 302 becomes small. Therefore, if the elastic supporting portion 302 is used for resonance, a large Q-value is obtained. Moreover, since fatigue breakdown due to repeated deformation does not occur as in the case of a metal material, an optical deflector having a long lifetime or the like can be configured.

Since the single-crystalline silicon can be processed with good accuracy by using a semiconductor circuit manufacturing technique, it is a suitable material for forming a mechanical component with high shape reproducibility. The elastic supporting portion 302, the movable plate 301 and the support substrate 310 can be integrally formed in the same substrate made of silicon by dry etching using a reactive gas or anisotropic etching using an alkaline aqueous solution. As a result, a structure without any junction as an independent member can be formed. In such a structure, an energy transfer efficiency at the junction is hardly decreased. Therefore, in the movable plate using resonance, a large Q-value can be obtained.

For the mirror surface, a material having a high reflection coefficient for light to be deflected is used. In a visible light range, aluminum, silver or the like is preferred. On the other hand, in an infrared range, aluminum, silver, gold, copper, rhodium or the like can be used.

The hard magnetic film 303 can be formed by a method of depositing a thin film made of Sm—Co, Co—Cr, Co—Pr, Co—P, Co—Ni, Ni—P or the like by means such as plating or sputtering. The hard magnetic film 303 can also be formed by a method of bonding an Fe—Co—Cr permanent magnet or a method of applying and solidifying a mixture of powder of a rare-earth permanent magnet represented by Nd—Fe—B into a paste adhesive. The hard magnetic film 303 is magnetized in a predetermined direction in a strong magnetic field to be a permanent magnet.

For the soft magnetic films 321a and 321b corresponding to the fixed cores, a magnetic material, which has a low retention, small residual magnetization, large saturation magnetization and a small loss, such as Fe—Ni (a permalloy), Fe—Si, Fe—N, Fe—Zr—Nb, or Co—Fe—B is used. By means such as plating or sputtering, the magnetic material can be formed as a thin film.

FIG. 15 shows magnetic flux lines of the magnetic field generated by planar wound coils through a simulation. FIG. 15 is viewed from the same sectional direction as that in FIG. 13. In FIG. 15, two horizontal lines represent coils. It is understood that a magnetic flux line distribution shows vertical symmetry about each of the coil surfaces. FIG. 16 shows the result of a simulation when the soft magnetic films are attached to the lower sides along the coil surfaces. In this case, it is understood that a magnetic flux line distribution shows vertical asymmetry about the coil.

Now, as shown in FIG. 17, if both ends (the right and left ends in FIG. 13) of the movable plate 301 interposing the rotational shaft (the elastic supporting portion) 302 therebetween are arranged in the vicinity of the inner end faces of the coils, an angle θ formed between a direction of a tangent line of the magnetic flux lines, that is, a direction of the magnetic field and a direction of the rotation of the movable plate 301 (a vertical direction in FIG. 17) becomes larger at a position B (the side opposite to the side where the planar coils are provided with respect to the plane formed by the soft magnetic films) in FIG. 17.

On the other hand, at a position A (the side where the planar coils are provided with respect to the plane formed by the soft magnetic films) in FIG. 17, the direction of the magnetic field is close to the direction of the rotation of the movable plate 301. Therefore, the number of components of the magnetic field contributing to the rotational movement of the movable plate 301 becomes larger. If the movable plate 301 is provided so that the magnetic flux at the N-pole and the S-pole of the movable plate 301 flows in a direction at a right angle to the N-to-S direction (in the horizontal direction in FIG. 17), the efficiency for the rotation of the movable plate becomes higher. In this regard, the arrangement at the position A in FIG. 17 is more excellent. In this arrangement, the movable plate 301 is positioned on the side opposite to the side of the soft magnetic films through the coil surfaces. Therefore, in this embodiment, the arrangement shown in FIG. 13 corresponding to the position A in FIG. 17 is employed. In this arrangement, the movable plate 301 having the hard magnetic film 303, the fixed cores (the soft magnetic films) 321a and 321b and the planar coils 322 are provided. The magnetic flux lines in FIG. 17 are illustrated in disregard of the magnetic effect of the movable plate 301. However, the above-described conclusion is still valid. Moreover, the movable plate 301 is illustrated as entirely serving as a magnet in FIG. 17.

This application claims priority from Japanese Patent Application No. 2004-319890 filed Nov. 2, 2004, which is hereby incorporated by reference herein.

What is claimed is:

1. An image forming apparatus, comprising:
an image bearing member, which moves.in a predetermined direction;
image forming means for forming an image on the image bearing member;
detecting means for detecting an image to be detected on the moving image bearing member at a detection position;
control means for controlling variably an image formation condition of the image forming means based on a result of detection by the detection means; and
moving means for moving the detection position of the detecting means in the predetermined direction while the detecting means is detecting the image to be detected.

2. An image forming apparatus according to claim 1, wherein there is a difference between a moving speed of the detection position and a moving speed of the image bearing member while the detecting means is detecting the image to be detected.

3. An image forming apparatus according to claim 2, wherein the moving speed of the detection position is slower than the moving speed of the image bearing member while the detecting means is detecting the image to be detected.

4. An image forming apparatus according to claim 3, wherein the image forming means forms an image on the image bearing member while the detecting means is detecting the image to be detected.

5. An image forming apparatus according to claim 4, wherein the moving means rotates the detecting means to move the detection position in a moving direction of the image bearing member.

6. An image forming apparatus according to claim 5, wherein the detecting means is an optical sensor having a light source, and the detection position is an irradiated position of light emitted from the light source.

7. An image forming apparatus according to claim 6, wherein the moving means changes a traveling direction of the light emitted from the light source fixed at a predetermined position to move the detection position in the predetermined direction.

8. An image forming apparatus according to claim 7, wherein the moving means includes a reflecting member for reflecting the light emitted from the light source to rotate the reflecting member about a rotational axis substantially perpendicular to the moving direction of the image bearing member, for moving the detection position along the moving direction of the image bearing member.

9. An image forming apparatus according to claim 1, wherein the moving means uses a driving force of a drive source for driving the image bearing member to move the detection position.

10. An image forming apparatus according to claim 1, wherein the.moving means uses a magnetic force to move the detection position.

11. An image forming apparatus according to claim 1, wherein the moving means uses a driving force of an independent drive source to drive the detection position.

12. An image forming apparatus according to claim 1, wherein the moving means rotates the detecting means to move the detection position in a moving direction of the image bearing member.

13. An image forming apparatus according to claim 1, wherein the image formation condition is at least one of a developer density in a developing device for supplying a developer to the image bearing member, information for tone correction, a charging condition of the image bearing member and a developing condition of an electrostatic image formed on the image bearing member.
